(19) United States
(12) Patent Application Publication
(10) Pub. No.: US 2016/0061096 A1
(43) Pub. Date: Mar. 3, 2016

(54) PRE-COMBUSTION CHAMBER WITH NOx REDUCING CATALYST

(71) Applicant: Caterpillar Inc., Peoria, IL (US)

(72) Inventor: Andrew J. Loetz, West Lafayette, IN (US)

(73) Assignee: Caterpillar Inc., Peoria, IL (US)

(21) Appl. No.: 14/934,175

(22) Filed: Nov. 6, 2015

(51) Int. Cl. F02B 19/18; F02B 75/10; F02B 77/02

(52) U.S. Cl. CPC F02B 19/18; F02B 77/02; F02B 75/10

(57) ABSTRACT

A combustion cylinder for an engine is disclosed. The combustion cylinder includes a main combustion chamber and a pre-combustion chamber. The pre-combustion chamber is fluidly connected to the main combustion chamber through a plurality of passages. The pre-combustion chamber includes an inner peripheral portion. The inner peripheral portion and the plurality of passages are coated with a layer of a NOx reducing catalyst.

### TECHNICAL FIELD

The present disclosure relates generally to an engine pre-combustion chamber having a number of passages fluidly connected to a main combustion chamber. More specifically, the present disclosure relates to a pre-combustion chamber coated with a layer of NOx reducing catalyst.

### BACKGROUND

Internal combustion engines (ICE) are commonly known to employ a number of combustion cylinders, where an air-fuel mixture is burnt to produce power required to run a machine. In certain internal combustion engine applications, such as gaseous fuel applications, the combustion cylinders define a pre-combustion chamber and a main combustion chamber. Typically, the pre-combustion chamber is located in a cylinder head and accommodates an air-fuel mixture. The pre-combustion chamber is in fluid communication with the main combustion chamber of the engine via a number of passages. During operation, a spark plug ignites the air-fuel mixture within the pre-combustion chamber. A resulting flame of burning fuel is then jetted or otherwise advanced through the passages into the main combustion chamber. This ignites an air-fuel mixture in the main combustion chamber.

As is customarily known, NOx gases are produced during ignition of the air-fuel mixture in the pre-combustion chamber and the main combustion chamber. The NOx gases of the pre-combustion chamber propagate with the resulting flame to the main combustion chamber and can contribute to a significant portion of the overall NOx produced. The engine typically employs a three-way catalyst to reduce the overall engine out NOx produced in the engine. Moreover, the engine is operated with a pre-combustion air-fuel mixture near stoich and a relatively lean main combustion air-fuel mixture. This makes the three-way catalyst ineffective at reducing the overall engine out NOx.

U.S. Pat. No. 5,307,772 discloses a pre-chamber insert positioned in pre-chamber (pre-combustion chamber) of an internal combustion engine. Although, the pre-chamber insert reduces the NOx formations produced in the pre-chamber, however positioning of the pre-chamber insert in the pre-chamber requires significant changes in a design of the internal combustion engine. Further, the '772 reference does not provide a solution for preventing NOx formation in the passages connecting the pre-combustion chamber and the main combustion chamber.

### SUMMARY OF THE INVENTION

Various aspects of the present disclosure are directed towards an engine that includes at least one combustion cylinder. The combustion cylinder includes a main combustion chamber and a pre-combustion chamber. The pre-combustion chamber is fluidly connected to the main combustion chamber through a plurality of passages. The pre-combustion chamber includes an inner peripheral portion. The inner peripheral portion and the plurality of passages are coated with a layer of a NOx reducing catalyst.

### BRIEF DESCRIPTION OF THE DRAWINGS

FIG. 1 is a sectional view of a portion of an engine, showing a pre-combustion chamber and a main combustion chamber, in accordance with the concepts of the present disclosure; and

FIG. 2 is a sectional view of a portion of the pre-combustion chamber of FIG. 1, shown in accordance with the concepts of the present disclosure;

### DETAILED DESCRIPTION

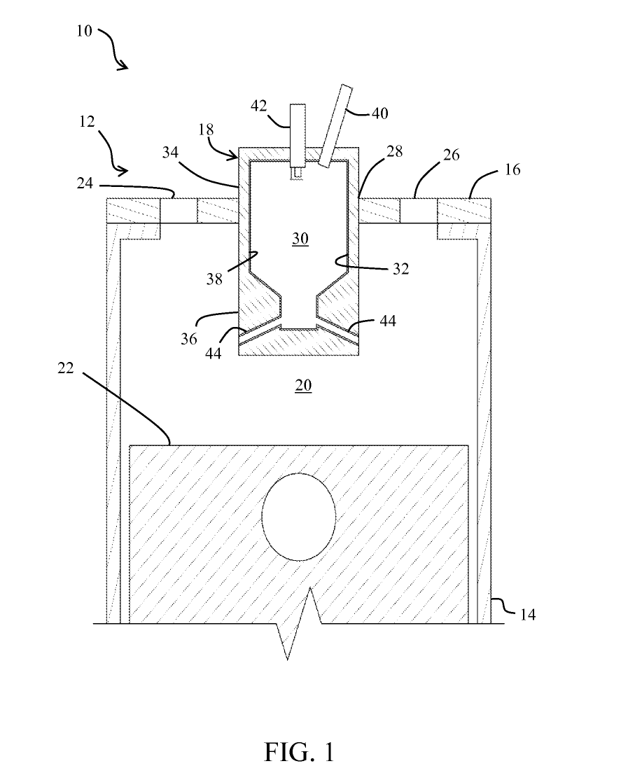

Referring to FIG. 1, there is shown an engine 10. The engine 10 is a gaseous fuel multi-cylinder internal combustion engine (ICE) that includes at least one combustion cylinder 12. For example, the engine 10 may include, but is not limited to, a six-cylinder V-layout ICE, a twelve-cylinder V-layout engine, and/or a six-cylinder in-line layout ICE. Although, the engine 10 is described as the multi-cylinder ICE, application of the concepts of the present disclosure to a singular cylinder ICE may also be contemplated.

The combustion cylinder 12 is a component of the engine 10, where an air-fuel mixture is burnt to produce required engine power. For ease in reference, structure and arrangement of a singular combustion cylinder 12 will be described in the disclosure, hereinafter. However, similar arrangement of several other combustion cylinders may be contemplated. The combustion cylinder 12 includes a main cylinder section 14, a cylinder head 16, and a pre-combustion unit 18.

The main cylinder section 14 is installed within an engine block (not shown) and defines a main combustion chamber 20 of the combustion cylinder 12. The main combustion chamber 20 is defined within an interior of the main cylinder section 14. A piston 22 is slideably positioned within the main combustion chamber 20 of the combustion cylinder 12. The piston 22 is adapted to reciprocate between a bottom dead center position and a top dead center position, corresponding to combustion of the air-fuel mixture in the main combustion chamber 20.

The cylinder head 16 is attached to the engine block (not shown), to cover the main cylinder section 14. The cylinder head 16 includes an intake port 24, an exhaust port 26, and a pre-combustion bore 28. Each of the intake port 24, the exhaust port 26, and the pre-combustion bore 28 are in fluid communication with the main combustion chamber 20 of the combustion cylinder 12. The intake port 24 facilitates a delivery of the air-fuel mixture to the main combustion chamber 20. The exhaust port 26 facilitates exhaust of burnt air-fuel mixture from the main combustion chamber 20. The pre-combustion bore 28 facilitates installation of the pre-combustion unit 18 on the main cylinder section 14.

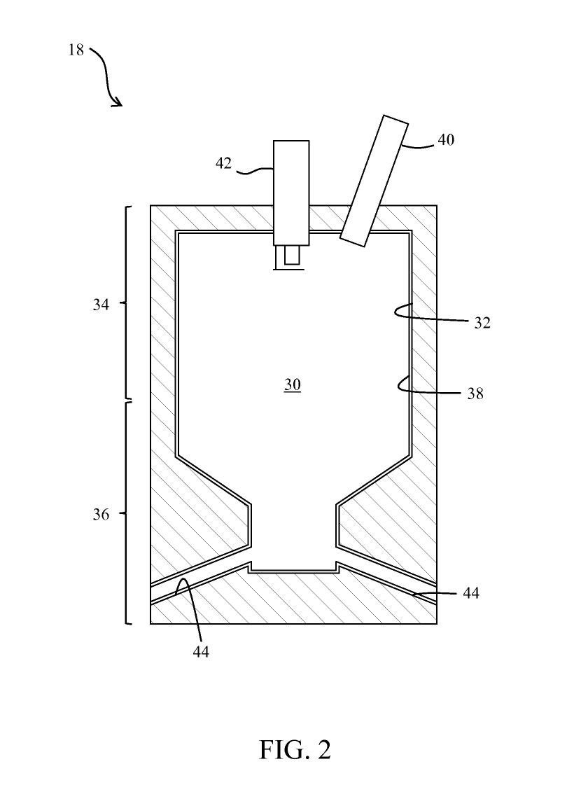

Referring to FIGS. 1 and 2, there is shown the pre-combustion unit 18 of the combustion cylinder 12. The pre-combustion unit 18 is installed in the pre-combustion bore 28 of the main cylinder section 14 and is adapted to facilitate combustion of the air-fuel mixture in the main combustion chamber 20. More specifically, the pre-combustion unit 18 facilitates combustion of a portion of the air-fuel mixture outside of the main combustion chamber 20, and direct the resulting flame into the main combustion chamber 20.

The pre-combustion unit 18 defines a pre-combustion chamber 30 of the combustion cylinder 12. The pre-combustion chamber 30 includes an inner peripheral portion 32. The inner peripheral portion 32 defines a space, where the pre-combustion unit 18 receives and burns a portion of the air-fuel mixture, to ignite the air-fuel mixture in the main combustion chamber 20. Additionally, the pre-combustion unit 18 includes a first section 34, a second section 36, and a NOx reducing catalyst 38 (FIG. 2).

The first section 34 of the pre-combustion unit 18 is positioned outwards, relative to the main combustion chamber 20 of the combustion cylinder 12. The first section 34 is adapted to support a fuel admission valve 40 and a spark plug 42. The fuel admission valve 40 and the spark plug 42 are positioned to be fluidly connected to the pre-combustion chamber 30 of the combustion cylinder 12. The fuel admission valve 40 is adapted to supply a portion of the air-fuel mixture to the pre-combustion chamber 30 and the spark plug 42 is adapted to ignite the received portion of air-fuel mixture.

The second section 36 of the pre-combustion unit 18 is positioned outwards, relative to the main combustion chamber 20 of the combustion cylinder 12. The second section 36 includes a plurality of passages 44. The passages 44 facilitate a fluid communication between the pre-combustion chamber 30 and the main combustion chamber 20. More specifically, the passages 44 are adapted to supply the air-fuel mixture burnt in the pre-combustion chamber 30 to the main combustion chamber 20 and therefore facilitate ignition of the air-fuel mixture in the main combustion chamber 20.

Referring to FIG. 2, there is shown an enlarged sectional view of the pre-combustion unit 18 of the combustion cylinder 12. The NOx reducing catalyst 38 is provided in the inner peripheral portion 32 of the pre-combustion chamber 30 and the passages 44. The NOx reducing catalyst 38 is a layer of NOx reducing material, such as but not limited to, a catalyst used in a NOx adsorber, or a catalyst used in a three-way catalyst. Examples of the NOx reducing material may include, but is not limited to, titanium oxide, molybdenum oxide, and tungsten oxide. The NOx reducing catalyst 38 is coated on the passages 44 and the inner peripheral portion 32 of the pre-combustion chamber 30. The NOx reducing catalyst 38 is adapted to reduce NOx gases produced in the pre-combustion chamber 30, during ignition of the air-fuel mixture in the pre-combustion chamber 30. In an alternate embodiment, a catalyst substrate element is filled in the passages 44 of the pre-combustion chamber 30, to reduce the NOx gases produced in the pre-combustion chamber 30. The catalyst substrate element also facilitates reduction of the NOx gases produced in the pre-combustion chamber 30, during ignition of the air-fuel mixture in the pre-combustion chamber 30.

### INDUSTRIAL APPLICABILITY

In operation, a fuel delivery system (not shown) supplies a portion of air-fuel mixture to the pre-combustion chamber 30, through the fuel admission valve 40. Additionally, the fuel delivery system (not shown) supplies remaining air-fuel mixture to the main combustion chamber 20 through the intake port 24 of the cylinder head 16. Thereafter, the spark plug 42 of the pre-combustion unit 18 ignites the air-fuel mixture in the pre-combustion chamber 30. This facilitates combustion of the air-fuel mixture in the pre-combustion chamber 30.

Combustion of the air-fuel mixture in the pre-combustion chamber 30 corresponds to formation of a mixture of a flame and NOx gases. This mixture passes through the passages 44 to the main combustion chamber 20. In so doing, the mixture interfaces with the NOx reducing catalyst 38 coated on the inner peripheral portion 32 and the passages 44. This facilitates reduction of the NOx gases produced in the pre-combustion chamber 30 and a relatively richer flame flows to the main combustion chamber 20, through the passages 44. Therefore, the flame facilitates relatively better combustion of the air-fuel mixture in the main combustion chamber 20. This results in relatively better fuel economy and reduced overall engine out NOx. Moreover, as the NOx reducing catalyst 38 is coated on the inner peripheral portion 32 and the passages 44, a need for significant design changes in the engine 10, is eliminated.

It should be understood that the above description is intended for illustrative purposes only and is not intended to limit the scope of the present disclosure in any way. One skilled in the art will appreciate that other aspects of the disclosure may be obtained from a study of the drawings, the disclosure, and the appended claim.

What is claimed is:

1. An engine, comprising:
at least one combustion cylinder, including:
a main combustion chamber; and
a pre-combustion chamber fluidly connected to the main combustion chamber through a plurality of passages, the pre-combustion chamber including an inner peripheral portion,
wherein the inner peripheral portion and the plurality of passages are coated with a layer of a NOx reducing catalyst.
